(19) United States
(12) Patent Application Publication
(10) Pub. No.: US 2002/0162234 A1
(43) Pub. Date: Nov. 7, 2002

(54) Novelty item

(76) Inventor: Moshe Ashin, Vineland, NJ (US)

Correspondence Address: LARSON & TAYLOR, PLC, 1199 NORTH FAIRFAX STREET, SUITE 900, ALEXANDRIA, VA, 22314, US

(21) Appl. No.: 09/845,834

(22) Filed: May 1, 2001

(51) Int. Cl. G01C 17/10

(52) U.S. Cl. 33/349; 33/352; 33/1 CC

(57) ABSTRACT

The invention provides a novelty item comprising a compass-like device having a housing and a magnetized compass needle suspended therein, the device further comprising a compass face positioned above the needle and hiding same from view, wherein the magnetized needle is rigidly attached, via a linking means, to a non-magnetized pointer positioned in a plane parallel to the plane of the magnetized compass needle above the compass face and angularly displaced from the magnetized compass needle, whereby the non-magnetized pointer always points to a direction other than North.

The present invention relates to a novelty item which can be used as a prayer aid. More particularly, the invention provides a compass which can be manufactured to point in any desired direction.

There is always a demand for novelty items. Items valued at a few dollars or more will generally be purchased by individuals for personal use or for use as a gift, while low-cost items ate often purchased in bulk by organizations for distribution as gifts for advertising purposes of by charitable organizations in appreciation of those giving support thereto. The item disclosed in the present specification is well suited to such purpose.

The use of magnets as aids to navigation can be traced back at least to the eleventh century. The North-pointing compass basically comprises a ferrous magnetized needle pivoted on a low friction bearing or supported in a suitable liquid. Due to the earth's magnetic field reacting with the poles of the magnetized needle, and said needle being freely suspended in a non-ferrous housing which is transparent to a magnetic field, said needle self-aligns in a direction corresponding to the North-South direction of the earth's magnetic field so that one arm of said needle, suitably marked or colored, always points North, hence the navigational use of the device.

Various improvements on the basic compass have been proposed, examples being disclosed in U.S. Pat. Nos. 4,055,902 to Jolley et al., 4,175,333 top Kramer, 4,700,490 to Kramer et al., 4,930,224 to LeBlanc and 5,146,687 to Kjellstrom. All prior-art compasses relate to finding global North or Magnetic North.

As is known, certain religions require that those engaged in prayer face in a specified direction. For example, Jews are required to face Jerusalem while reciting the “Amidah” (standing) prayer, while Muslims are required to pray while facing Mecca. People who are outside their own homes or away from their normal house of worship are often in doubt as to the correct direction to face while praying.

A solution used at present is to view a standard compass. Having ascertained thereby which direction is North, and considering the person's position relative to the city which is to be faced, the correct deduction can be made. For example, a person in India wishing to pray while facing West may use a standard compass to ascertain North. Thereafter he/she turns 90° anti-clockwise to face in the correct direction.

There is no doubt that a more direct and easier to use method would be useful, particularly for less-educated worshippers. However, a search of prior art for such device produced only improvements to North-pointing compasses but nothing relevant to the present disclosure.

It is therefore one of the objects of the present invention to provide a novelty item comprising an unusual compass.

It is a further object of the present invention to provide an indicator for the direction which should be faced while praying.

Yet a further object of the present invention is to provide a compass which closely resembles the appearance of a standard North-pointing compass yet which points in another direction.

The present invention achieves the above objects by providing a novelty item comprising a compass-like device having a housing and a magnetized compass needle suspended therein, said device further comprising a compass face positioned above said needle and hiding same from view, wherein said magnetized needle is rigidly attached, via a linking means, to a non-magnetized pointer positioned in a plane parallel to the plane of said magnetized compass needle above said compass face and angularly displaced from said magnetized compass needle, whereby said non-magnetized pointer always points to a direction other than North.

In a preferred embodiment of the present invention there is provided a novelty item wherein said non-magnetized pointer is angularly displaced from said magnetized compass needle at an angle of about 90° and positioned to always point to the East.

In a most preferred embodiment of the present invention there is provided a novelty item wherein the non-magnetized pointer is shaped and colored to provide an appearance similar to that of a magnetized compass needle used in a normal compass.

It will thus be realized that the novel device of the present invention can be marketed in different countries with a pointer oriented to match the direction towards which prayers should be recited. For example, a compass indicating South can be marketed in Finland and Russia, a compass directed towards East can be marketed in the USA and Mexico and a compass indicating West can be sold in India, Pakistan, Burma and Japan. Intermediate directions, for example South-West, would be suitable for Mid-Europe and the UK.

The compass face can be used to carry an advertising message or an appropriate message of religious significance. For those familiar with the Bible, a suitable verse relating to prayer direction can be selected therefrom.

In preferred embodiments of the invention an element of mystery is added by the pointer appearing to defy the laws of physics by pointing in a direction other than North, By allocating only the minimum space needed to the chamber containing the magnetized compass needle, while allowing a more generous allocation of space for the non-magnetized dummy pointer, the existence of the magnetized needle can be most difficult to discover and thus increase the mystery of the pointer indicating a direction other than North. Furthermore, as the non-magnetized pointer can easily be made to appear as if it were a standard compass magnetized needle, a viewer is most unlikely to understand why the device acts in an apparently inexplicable manner.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### IN THE DRAWINGS

FIG. 1a is a fragmented perspective view of a preferred embodiment of the compass according to the invention;

FIG. 1b is a sectioned detail of the central support shaft;

FIG. 2 is a plan view of an East-pointing embodiment;

FIG. 3 is a fragmented perspective view of an embodiment provided with a narrow lower chamber;

FIG. 4 is a plan view of an embodiment wherein the non-magnetized pointer is arranged to appear as if it were a standard magnetized compass needle.

There is seen in FIG. 1a novelty item comprising a compass-like device 10 having a non-transparent housing 12. Suitably the housing 12 can be made of a non-ferrous metal or a non-transparent plastic such as a phenolic.

A transparent top face 14, which can suitably be made of a clear acrylic thermoplastic, seals an open upper face of the housing 12.

A magnetized compass needle 16 is pivotally suspended in the lower section 18 of the housing 12. An opaque compass face 20 positioned above the magnetized needle 16, in combination with the housing 12, hides the needle 16 from view.

The magnetized needle 16 is rigidly attached, via a linking means seen in FIG. 1b, to a non-magnetized pointer 22. The pointer 22 is clearly visible through the transparent top face 14 of the housing 12, and is positioned in a plane parallel to the plane of the magnetized compass needle 16 and above the compass face 20, The pointer 22 is angularly displaced from the magnetized compass needle 16, whereby the non-magnetized pointer 22 always indicates a direction other than North.

FIG. 1b shows a suitable linking means and suspension arrangement for the magnetized needle 16 and the non-magnetized pointer 22. Whether a simple pointed lower bearing 24, as shown, is used, or a jewel bearing (not shown) is to support the central shaft 26 is merely a question of whether to market a low-cost or high quality device.

Both the non-magnetized pointer 22 and the magnetized compass needle 16 are rigidly attached to the shaft 26, the compass face 20 therebetween providing the upper bearing 28. The angle between the non-magnetized pointer 22 and the magnetized compass needle 16 is factory set in accordance with the geographical location in which the device is to be marketed.

It will be realized that many alternative configurations of the pivotal support are possible. For example, the compass disk and magnetic needle could be an integral unit suspended to be revolvable, while the non-magnetized pointer is fixed, and could appear as a printed or painted arrow on or under the transparent top cover.

With regard to the rest of the figures, similar reference numerals have been used to identify similar parts.

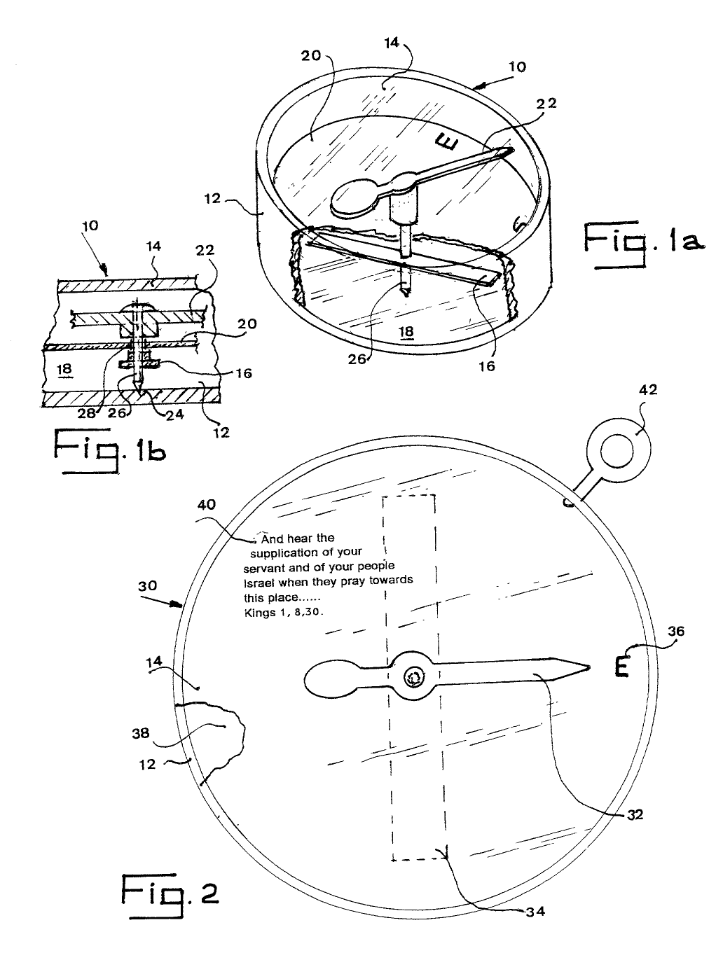

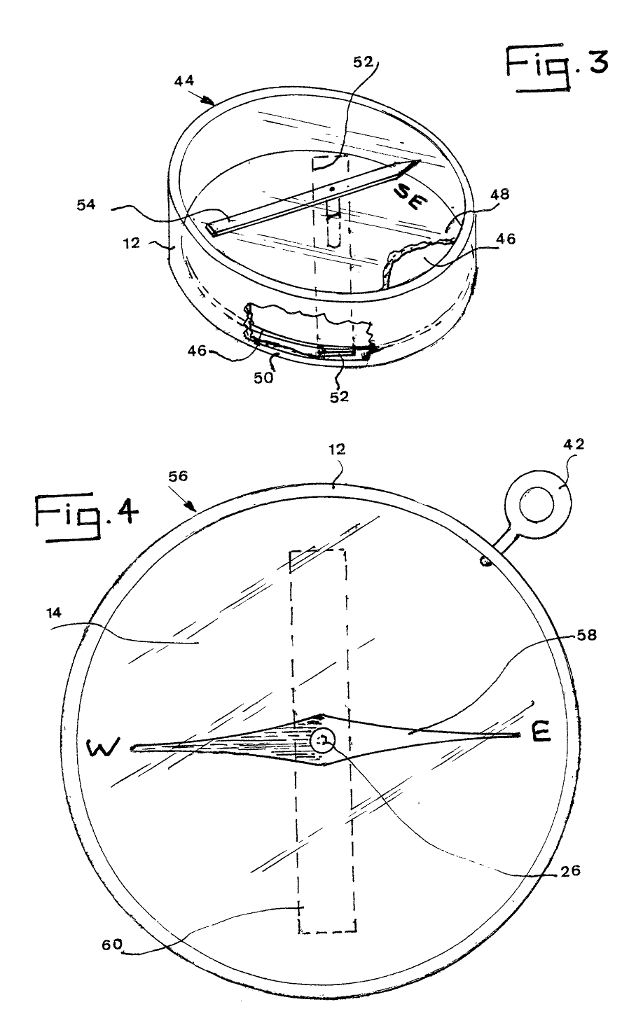

Referring now to FIG. 2, there is seen a novelty item 30 wherein the non-magnetized pointer 32 is angularly displaced from the magnetized compass needle 34 at an angle of about 90° and positioned to always point to the East. The item of the present embodiment is suitable for sale to users in the USA and Mexico. The eastern direction is marked, suitably by a large E 36, while other directions are unmarked.

In the present embodiment, the compass face 38 carries a message 40 of religious significance relating to the direction indicated by said non-magnetized pointer 22. The verse quoted from Kings 1, 8, 30 forms the basis for the regulation in Jewish law requiring worshippers to face the site of the Temple in Jerusalem.

The present embodiment is provided with an attachment ring 42 for convenience in retaining the item on a key chain or ring.

FIG. 3 illustrates a novelty item 44 wherein the distance between the compass face 46 and the housing top cover 48 is at least twice the distance between the compass face 46 and the housing base 50. For example, the distance between the compass face 46 and the housing top cover 48 is 10 mm and the distance between the compass face 46 and the housing base 50 is 3 mm. By allocating only minimum space to the magnetized compass needle 52, detection thereof is unlikely and the user is intrigued by the action of the visible but non-magnetized pointer 54 which indicates a direction other than North.

Seen in FIG. 4 is a further embodiment 56 of the novelty item. The visible non-magnetized pointer 58 is shaped and colored to provide an appearance similar to that of a magnetized compass needle used in a normal compass. As the magnetized needle 60 is not visible, a viewer has no means of knowing that the visible pointer 58 is a non-magnetic dummy, and will be much perplexed at the direction indicated by pointer 58.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A novelty item comprising a compass-like device having a housing and a magnetized compass needle suspended therein, said device further comprising a compass face positioned above said needle and hiding same from view, wherein said magnetized needle is rigidly attached, via a linking means, to a non-magnetized pointer positioned in a plane parallel to the plane of said magnetized compass needle above said compass face and angularly displaced from said magnetized compass needle, whereby said non-magnetized pointer always points to a direction other than North.

2. A novelty item according to claim 1, wherein said non-magnetized pointer is angularly displaced from said magnetized compass needle at an angle of about 90° and positioned to always point to the East.

3. A novelty item according to claim 1, wherein said housing is non-transparent except for a transparent top face.

4. A novelty item according to claim 1, wherein the distance between said compass face and the housing top cover is at least twice the distance between said compass face and the housing base.

5. A novelty item according to claim 2, wherein said compass face carries a message of religious significance relating to the direction indicated by said non-magnetized pointer.

6. A novelty item according to claim 1, wherein said non-magnetized pointer is shaped and colored to provide an appearance similar to that of a magnetized compass needle used in a normal compass.
